(19) United States
(12) Patent Application Publication
(10) Pub. No.: US 2014/0076589 A1
(43) Pub. Date: Mar. 20, 2014

(54) WATER MIST FIRE EXTINGUISHER

(71) Applicant: HON HAI PRECISION INDUSTRY CO., LTD., New Taipei (TW)

(72) Inventors: SHIH-CHENG WANG, New Taipei (TW); YI-WEN CAI, New Taipei (TW)

(21) Appl. No.: 13/912,296

(22) Filed: Jun. 7, 2013

(30) Foreign Application Priority Data
Sep. 20, 2012 (TW) 101134397

(51) Int. Cl. A62C 99/00

(52) U.S. Cl. CPC A62C 99/0072; A62C 99/0027
USPC 169/75; 169/78

(57) ABSTRACT

A fire extinguisher includes an accommodating unit, a catalytic unit, and an output unit. The accommodating unit holds carbonated water. The catalytic unit includes catalyst for accelerating decomposition of the carbonated water into carbon dioxide and water. The output unit includes water mist nozzles. The water mist nozzles spew gas and water from the accommodating unit in a mist form, providing a manner of absorbing heat from the fire as the water mist is turned into steam, to suppress the fire. The fire extinguisher can be thrown into the fire from a distance, reducing burn-injury risk to personnel.

### BACKGROUND

1. Technical Field

The present disclosure relates to fire extinguishers, and especially relates to a water mist fire extinguisher.

2. Description of Related Art

At the scene of a fire, firemen in a smoky and high temperature environment can only extinguish the fire one by one from outside to inside. It is very difficult to enter the scene of the fire. Especially when the fire is in a narrow area, a fire engine cannot get close to the scene, which will waste a lot of time to prepare equipment to extinguish the fire. Furthermore, a large number of sprinklers just waste water.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of an embodiment of a part of a water mist fire extinguisher of the present disclosure.

FIG. 2 is a block diagram of an embodiment of the water mist fire extinguisher of FIG. 1.

### DETAILED DESCRIPTION

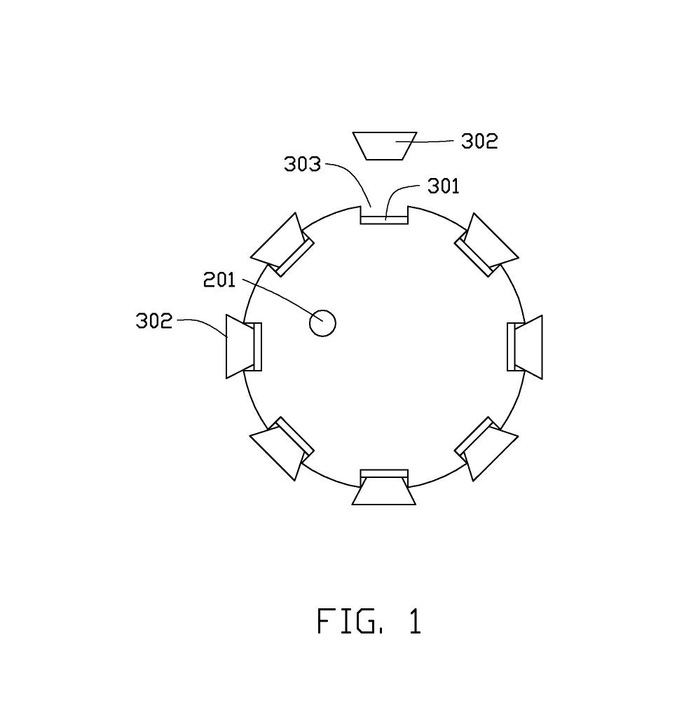

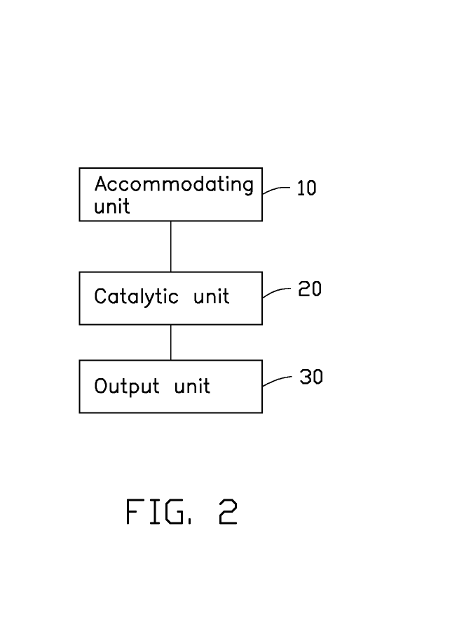

FIGS. 1 and 2 show an embodiment of a water mist fire extinguisher of the present disclosure. The water mist fire extinguisher includes an accommodating unit 10, a catalytic unit 20, and an output unit 30. The accommodating unit 10 holds carbonated water. The catalytic unit 20 accelerates decomposition of the carbonated water into carbon dioxide and water. The output unit 30 allows for the escape of the carbon dioxide and water.

The accommodating unit 10 is spherical. At the scene of a fire, the fire would spread with heat flow, and a spherical container would be easily to scroll at the scene of the fire. In this embodiment, the diameter of the spherical container is between 10 centimeters (cm) and 30 cm, but the disclosure is not limited thereto.

The catalytic unit 20 includes catalyst (such as coarse salt, etc) and a trigger device 201. In this embodiment, the trigger device 201 is a button positioned on an outside surface of the spherical container. When the button is pressed, the catalyst contacts the carbonated water and accelerates the decomposition of the carbonated water. The carbonated water decomposes into carbon dioxide and water, where the carbon dioxide gas generates a high pressure inside the accommodating unit 10. In other embodiments, the trigger device 201 can be a slide switch.

The output unit 30 includes a plurality of water mist nozzles 301. A plurality of grooves 303 are defined in the surface of the spherical container. The water mist nozzles 301 are mounted to the bottoms of the grooves 303. Each water mist nozzle 301 is connected to the inside of the accommodating unit 10. The water mist nozzles 301 spews the water from the accommodating unit 10 in the form of mist (water droplets under 1000 microns in diameter). The water mist rapidly absorbs heat to change into steam, which is less wasteful of water. The output unit 30 also includes a plurality of blowout preventers 302. The blowout preventers 302 cover the water mist nozzles 301 to avoid leakage of the carbonated water when the water mist fire extinguisher 10 is not in use. The blowout preventers 302 are removed from the water mist nozzles 301 for use.

In this embodiment, when using the water mist fire extinguisher 10, the blowout preventers 302 are removed and the trigger device 201 is triggered. The carbonated water starts to decompose and the decomposition generates high pressure inside the accommodating unit 10. Carbon dioxide and water mist are spewed out through the water mist nozzles 301. The water mist absorbs the heat and the carbon dioxide gas also reduces the available oxygen to starve and suppress the fire. The water mist fire extinguisher 10 can be thrown physically into the fire from a distance to suppress the fire, which could reduce burn-injury risk to personnel.

While the disclosure has been described by way of example and in terms of preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A water mist fire extinguisher, comprising:
an accommodating unit containing carbonated water;
a catalytic unit comprising catalyst for accelerating a process of the carbonated water decomposing into carbon dioxide and water, to generate high pressure inside the accommodating unit; and
an output unit positioned on an outside surface of the accommodating unit and connected to the inside of the accommodating unit, wherein the carbon dioxide and the water are spewed out of the accommodating unit through the output unit.

2. The water mist fire extinguisher of claim 1, wherein the accommodating unit is a spherical container.

3. The water mist fire extinguisher of claim 1, wherein the catalytic unit further comprises a trigger device, and when the trigger device is triggered, the catalyst contacts the carbonated water.

4. The water mist fire extinguisher of claim 1, wherein the output unit further comprises at least a water mist nozzle, and the carbon dioxide and the water are spewed out in a form of mist through the of water mist nozzle.

5. The water mist fire extinguisher of claim 4, wherein the output unit further comprises at least a blowout preventers detachably covers the water mist nozzle, the blowout preventer covers the water mist nozzle to avoid leakage of the carbonated water.
